(19) United States
(12) Patent Application Publication
(10) Pub. No.: US 2008/0032681 A1
(43) Pub. Date: Feb. 7, 2008

(54) Click-hold Operations of Mobile Device Input Keys

(75) Inventor: Jennifer Denise West, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/461,483

(22) Filed: Aug. 1, 2006

(51) Int. Cl. H04M 3/00

(52) U.S. Cl. 455/418

(57) ABSTRACT

The invention described herein executes different functions on a mobile device based on different actuation times associated with input key or control. According to one embodiment, the mobile device outputs different alphanumeric characters based on different actuation times associated with an alphanumeric input key. According to another exemplary embodiment, the mobile device invokes different menus based on different actuation times associated with a menu selection input control.

### BACKGROUND

The invention relates generally to mobile devices, and more particularly to mobile device text entry.

Mobile telephones require the user to enter text to implement or use various functions, such as email, text messaging, etc. Some conventional mobile telephones require the user to use an alphanumeric keypad to enter alphanumeric characters. Other conventional mobile telephones include a miniature keyboard, such as a QWERTY keyboard, that may be used instead of the alphanumeric keypad for text entry. In either case, entering lowercase letters is fairly straightforward. However, entering capital letters and various other typographical symbols, including punctuation marks, requires 1-3 extra steps per character. This makes text entry time consuming.

Conventional mobile telephones may include various features that facilitate text entry. For example, some mobile telephones may include a list of canned phrases from which the user may select. Further, some mobile telephones may include a pattern recognition mode that generates a commonly used word based on an entered alphanumeric sequence. While these options facilitate text entry, they do not address the overall problem associated with generating alphanumeric characters that differ from simple lowercase letters. As such, there remains a need for alternative text entry options.

### SUMMARY

The present invention executes different functions on a mobile device based on different actuation times associated with an input key or control. According to one embodiment, the mobile device outputs different alphanumeric characters based on the actuation time of an alphanumeric input key. For this embodiment, a timer in the mobile device monitors the actuation time. When the actuation time has a first duration, a processor in the mobile device outputs a first alphanumeric character. When the actuation time of the same key has a second duration, the processor outputs a second alphanumeric character. Exemplary alphanumeric characters include, but are not limited to, lowercase letters, uppercase letters, punctuation marks, symbols, and other typographical characters.

According to another exemplary embodiment, the mobile device invokes different menus based on the actuation time of a menu selection input control. For this embodiment, the processor invokes a first menu of options when the actuation time has a first duration. When the actuation time for the same control has a second duration, the processor invokes a second menu of options.

### BRIEF DESCRIPTION OF THE DRAWINGS

FIG. 1 shows an exemplary mobile device.

FIG. 2 shows a process diagram for implementing one embodiment of the present invention.

FIG. 3 shows a process diagram for implementing another embodiment of the present invention.

FIG. 4 shows a block diagram for an exemplary mobile device according to the present invention.

FIG. 5 shows another exemplary mobile device.

FIG. 6 shows a process diagram for implementing another embodiment of the present invention.

### DETAILED DESCRIPTION

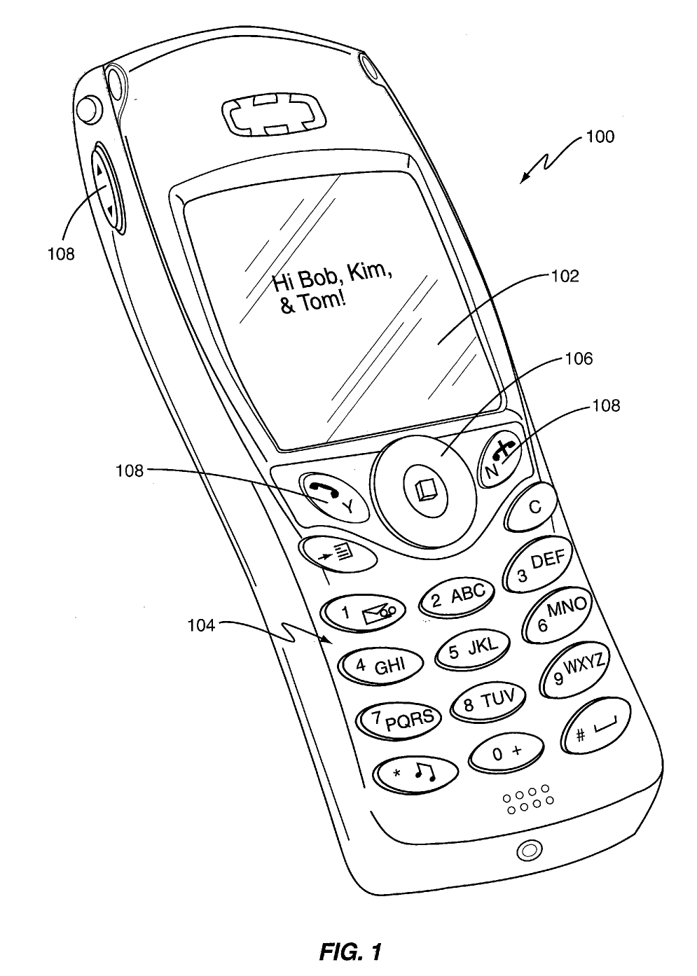

The present invention applies to any mobile device, including cellular telephones, personal data assistants, palmtop computers, etc. FIG. 1 shows one exemplary mobile device 100 having a display 102, an alphanumeric keypad 104, and input control buttons, such as a joystick 106 and option controls 108. Display 102 displays information to the user. The user may use keypad 104, joystick 106, and option controls 108 to input information and instructions, navigate menus, and otherwise control mobile device 100. It will be appreciated that a user may actuate an input key/control by pressing the key/control. The user may de-actuate the key/control by releasing the key/control. While FIG. 1 illustrates a mechanical keypad 104 and mechanical controls 106, 108, those skilled in the art will appreciate that other keypads 104 and controls 106, 108 may be used, including a virtual keypad and/or control displayed on display 102.

When in a text entry mode, the user uses keypad 104 to enter the text. The entered text is output to an output device, such as display 102. For example, the user may enter the text displayed in FIG. 1. Because conventional keypads only provide direct access to lowercase letters, entering capital letters, punctuation marks, and other typographical characters requires additional actuations of one or more keys. For example, entering the 15-character message displayed in FIG. 1 may require in the range of 40-50 key presses. As a result, text entry using conventional mobile devices is often cumbersome.

The present invention increases the ease of entering text by reducing the number of key presses required to enter desired text. More particularly, a mobile device 100 according to the present invention outputs a desired alphanumeric character based on how long a specific key in alphanumeric keypad 104 is actuated. When the actuation time has a first duration, a processor in the mobile device outputs a first alphanumeric character, e.g., to a display of the mobile device. When the actuation time of the same key has a second duration, the processor outputs a second alphanumeric character to the display.

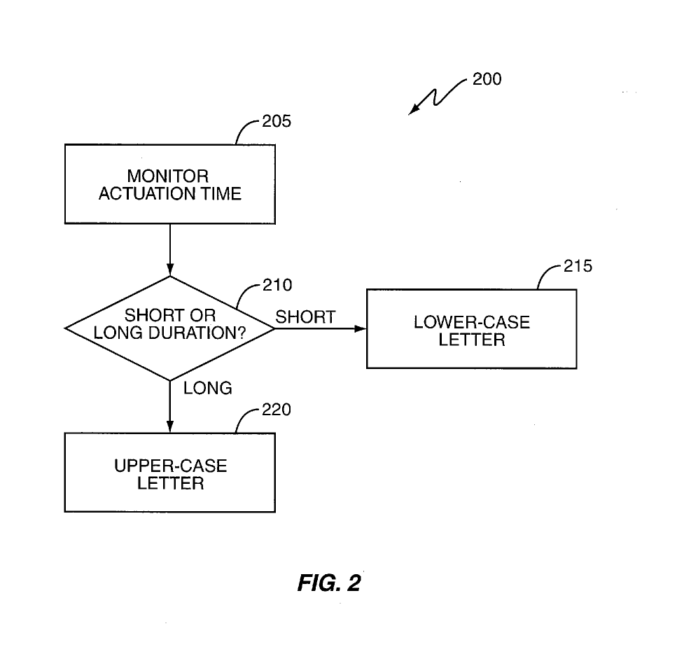

FIG. 2 shows one exemplary process 200 for text entry using a keypad 104. When a user actuates a key in keypad 104, mobile device 100 monitors the corresponding actuation time (block 205). When the actuation time is short (block 210), mobile device 100 outputs a lowercase letter corresponding to the actuated key (block 215). When the actuation time is long (block 210), mobile device 100 outputs the corresponding uppercase letter (block 220). For example, when the “2” key in keypad 104 is briefly actuated, display 102 outputs the “a” character. When the “2” key is actuated for a longer time, display 102 displays the “A” character. It will be appreciated that the uppercase letter may be achieved by holding the last key press for the appropriate letter. For example, briefly pressing the “2” key twice outputs the “b” character, while pressing the “2” key twice and holding the “2” key down on the second press outputs the “B” character

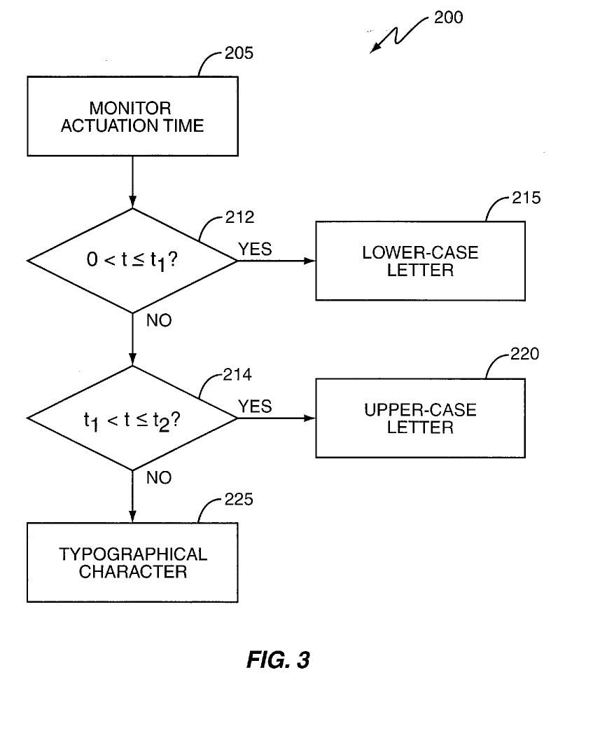

The above generally describes outputting lower and uppercase letters based on actuating a key on keypad 104 for one of two different durations. It will be appreciated, however, that the preset invention is not limited to this implementation. Generally, different characters may be output based different actuation times associated with a key in the alphanumeric keypad 104. FIG. 3 illustrates one exemplary process 200 for this generalized embodiment. As with the previous embodiment, mobile device 100 monitors an actuation time associated with a key on keypad 104 (block 205). When the actuation time is of a first length, i.e., between 0 and t₁ (bloc 212), a lowercase letter is output (block 215). When the actuation time is of a second length, i.e., between t₁ and t₂ (block 214), an uppercase letter is output (block 220). When the actuation time is of a third length, i.e., greater than t₂ (block 214), a typographical character is output. For example, assume the “2” key is associated with the “@” character. In this example, pressing the “2” causes display 102 to display the “a” character, the “A” character, or the “@” character, depending on how long the user holds down the “2” key.

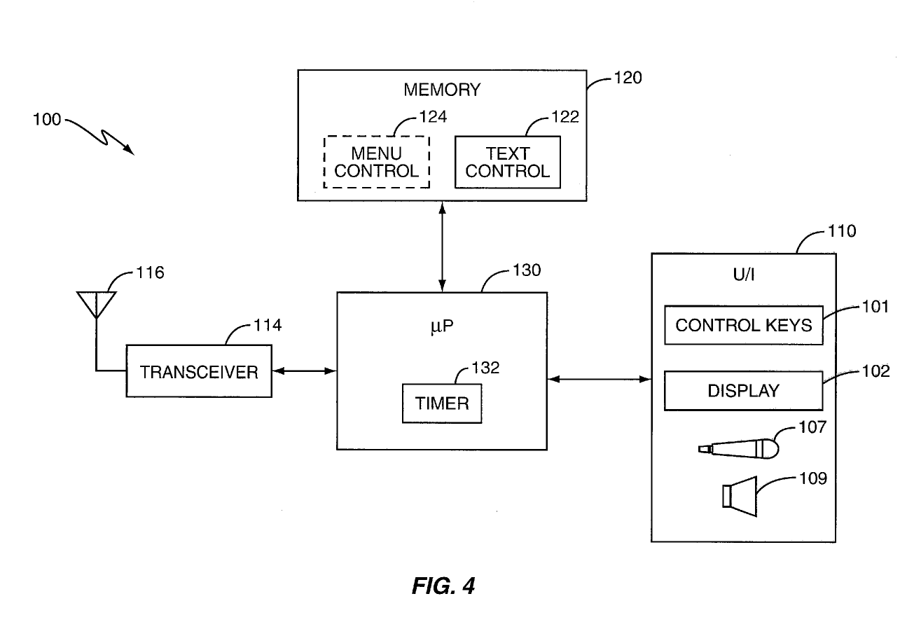

FIG. 4 shows a block diagram of one exemplary mobile device 100 that may be used to implement the above-described processes. Mobile device 100 includes a user interface 110, memory 120, and processor 130. User interface 110 enables the user to interact with the mobile device 100. The user interface 110 includes display 102, one or more input controls 101, including keypad 104, a microphone 107, and a speaker 109. Processor 130 performs various processing tasks, including control of the overall operation of mobile device 100, according to programs stored in memory 120, which stores data and programs needed for operation. When mobile device 100 is a mobile communication device, mobile device 100 may also include a transceiver 114 and antenna 116. Transceiver 114 may operate according to any known standard. Exemplary communication standards include but are not limited to, Code Division Multiple Access (CDMA), Global System for Mobile Communications (GSM), Universal Mobile Telecommunications System (UMTS), Orthogonal Frequency Division Multiplexing (OFDM), etc.

To implement any of the above-described processes, memory 120 may store a text editing function 122 that is executed by processor 130. The processor 130 may include a timer 132 that measures the actuation time associated with a key on keypad 104. Timer 132 starts when a key is pressed and stops when a key is released. The text editing function 122 outputs a character based on the actuation time provided by timer 132. The text editing function 122 may output the character to any desired output element, including but not limited to, display 102, transceiver 114, and/or memory 120. It will be appreciated that while FIG. 3 shows timer 132 as part of processor 130, those skilled in the art will appreciate that timer 132 may be implemented externally from processor 130. Further, while FIG. 4 shows the text editing function 122 as a program stored in memory 120, those skilled in the art will appreciate that the text editing function 122 may be embodied in hardware and/or in software (including firmware, resident software, micro-code, etc.), including an application specific integrated circuit (ASIC).

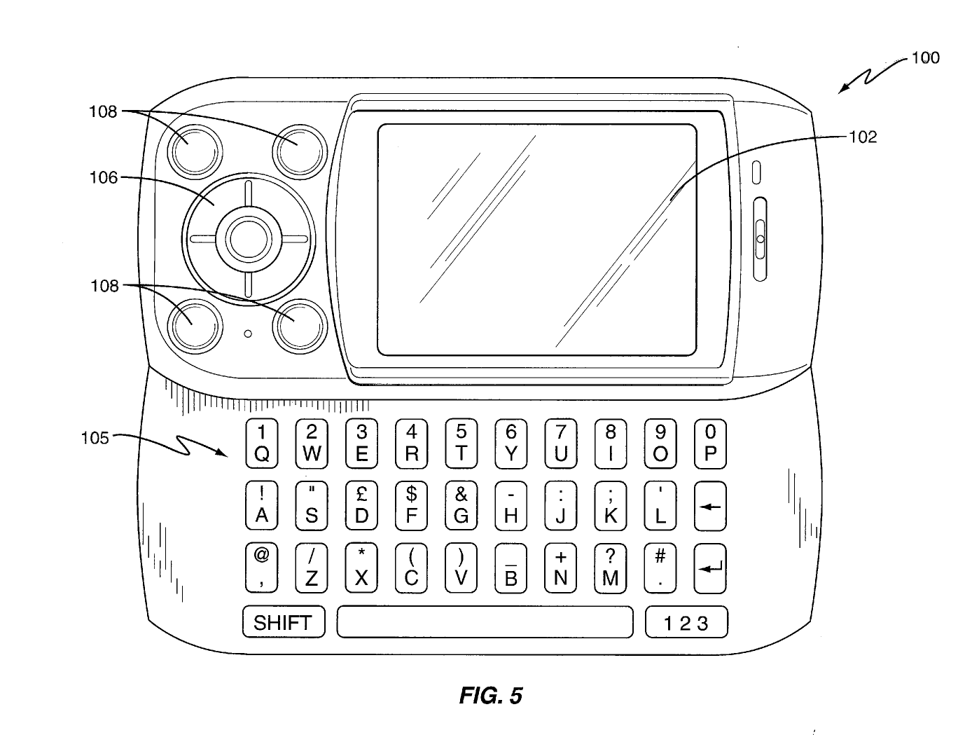

FIG. 5 illustrates one alternate embodiment of a mobile device 100 having a full keyboard 105, such as a QWERTY keyboard. Keyboard 105 may be laid out according to any known format. For this embodiment, briefly actuating a key on keyboard 105 causes the character on the lower portion of the actuated key to be displayed on display 102. Actuating the same key for a longer duration causes the uppercase version of the character to be displayed. Alternatively or in addition, actuating the same key for an even longer duration causes the character on the upper portion of the actuated key to be displayed.

The above described embodiments reduce the number of key presses required to enter desired text into a mobile device 100. As a result, using common text functions, such as email, text messaging, etc., becomes less cumbersome. As an example, consider the message displayed in FIG. 1. On a conventional mobile phone, entering the displayed message using an alphanumeric keypad requires approximately 40-50 key presses. Using the method of FIG. 2 may save the user approximately 3-5 key presses, while using the method of FIG. 3 may save the user approximately 7-11 key presses.

While the above describes the present invention in terms of text entry, the present invention may also be used to invoke different menus based on how long the user actuates an input control, such as joystick control 106. Exemplary menus include a messages menu, a contacts menu, a calls menu, a settings menu, etc. Each menu may include characters, lists, images, or other elements used to present a menu of options to the user. To implement this embodiment, memory 120 may optionally store a menu control function 124 (shown in FIG. 4) that is executed by processor 130. While FIG. 4 shows the menu control function 124 as a program stored in memory 120, those skilled in the art will appreciate that the menu control function 124 may be embodied in hardware and/or in software (including firmware, resident software, micro-code, etc.), including an application specific integrated circuit (ASIC).

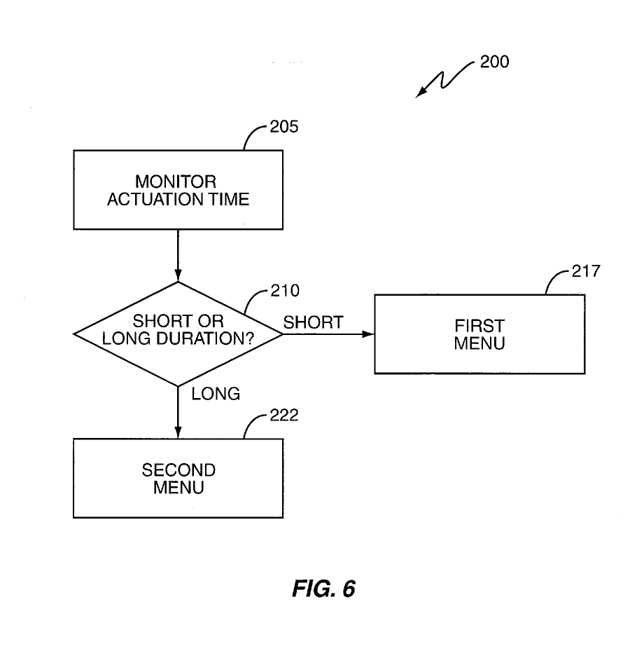

FIG. 6 illustrates one exemplary menu control process 200. When mobile device 100 is not in a navigation mode, and when the user actuates joystick control 106, timer 132 monitors the actuation time (block 205). The menu control function 124 invokes a first menu of options (bock 217) when the actuation time has a short duration (block 210), i.e., between 0 and t₁. When actuation time has a long duration (block 210), i.e., greater than t₁, the menu control function 124 invokes a second menu of options (block 222). In either case, the invoked menu is displayed on display 102. It will be appreciated that additional durations may be utilized to associate additional menus with joystick control 106. Further, it will be appreciated that the menu control function may be executed responsive to user actuation of other menu selection input controls, including option controls 108.

One of the advantages of the menu control embodiment is that it incorporates multiple functions onto a single control key 106, 108. As such, the menu control embodiment may be used to reduce the number of control keys 106, 108 on mobile device 100. Not only does reducing the number of control keys 106, 108 provide a more streamlined look to mobile device 100, but it also frees up valuable space inside the mobile device 100 and on the external surface for other elements.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of generating different alphanumeric characters for display on a mobile device, the method comprising:
monitoring an actuation time of an alphanumeric input key;
outputting a first alphanumeric character responsive to the actuation time having a first duration; and
outputting a second alphanumeric character responsive to the actuation time having a second duration.

2. The method of claim 1 wherein the first alphanumeric character comprises a lowercase letter and wherein the second alphanumeric character comprises an uppercase version of the lowercase letter.

3. The method of claim 1 wherein the first duration is shorter than the second duration.

4. The method of claim 1 further comprising outputting a third alphanumeric character responsive to the actuation time having a third duration.

5. The method of claim 1 further comprising:
storing in memory a group of two or more alphanumeric characters;
linking the group of alphanumeric characters to the alphanumeric input key; and
selecting one of the alphanumeric characters from the group of alphanumeric characters as the first or second alphanumeric character based on a duration of the actuation time.

6. The method of claim 1 wherein monitoring the actuation time comprises monitoring the time that the alphanumeric input key is depressed.

7. The method of claim 1 wherein outputting the first alphanumeric character comprises displaying the first alphanumeric character on a display of the mobile device responsive to the actuation time having the first duration, and wherein outputting the second alphanumeric character comprises displaying the second alphanumeric character on the display responsive to the actuation time having the second duration.

8. A mobile device operative to generate different alphanumeric characters for display, the mobile device comprising:
an alphanumeric input key;
an output element;
a timer operatively connected to the alphanumeric input key and configured to determine an actuation time of the alphanumeric input key; and
a processor operatively connected to the timer, the alphanumeric input key, and a display and configured to:
output a first alphanumeric character to the output element responsive to the actuation time having a first duration; and
output a second alphanumeric character to the output element responsive to the actuation time having a second duration.

9. The mobile device of claim 8 wherein the first alphanumeric character comprises a lowercase letter and wherein the second alphanumeric character comprises an uppercase version of the lowercase letter.

10. The mobile device of claim 8 wherein the processor is further configured to output a third alphanumeric character to the output element responsive to the actuation time having a third duration.

11. The mobile device of claim 8 wherein the timer is configured to determine the actuation time of the alphanumeric input key by starting a timing operation responsive to the alphanumeric input key being actuated and stopping the timing operation responsive to the alphanumeric input key being subsequently de-actuated.

12. The mobile device of claim 8 wherein the processor outputs the first and second alphanumeric characters to the output element by executing a text control function, said text control function configured to output the first alpha-numeric character to the output element responsive to the actuation time having the first duration and to output the second alphanumeric character to the output element responsive to the actuation time having the second duration.

13. The mobile device of claim 8 further comprising at least one of a keypad and a keyboard, wherein the alphanumeric input key is part of at least one of the keypad and the keyboard.

14. A method of displaying different menus on a mobile device, the method comprising:
monitoring an actuation time of a menu selection input control having an actuating position and a non-actuating position, said actuation time corresponding to a time the menu selection input control is in the actuating position; and
invoking different menus based on a duration of the actuation time.

15. The method of claim 14 wherein invoking different menus comprises:
invoking a first menu responsive to the actuation time having a first duration; and
invoking a second menu responsive to the actuation time having a second duration.

16. The method of claim 14 wherein invoking different menus comprises executing a menu control function in a processor operatively connected to the menu selection input control, said menu control function configured to invoke different menus responsive to the duration of the actuation time.

17. The method of claim 14 wherein the menu selection input control is operatively connected to a timer, and wherein monitoring the actuation time of the menu selection input control comprises starting the timer when the menu selection input control is actuated and stopping the timer when the menu selection input control is de-actuated.

18. The method of claim 14 wherein the menu selection input control comprises a non-alphanumeric input control.

19. The method of claim 18 wherein the menu selection input control comprises one of a joystick control and an options control.

20. A mobile device operative to display different menus, the mobile device comprising:
a menu selection input control having an actuating position and a non-actuating position;
a timer operatively connected to the menu selection input control and configured to determine an actuation time of the menu selection input control; and
a processor operatively connected to the menu selection input control and the timer, and configured to invoke different menus based on the actuation time.

21. The mobile device of claim 20 wherein the processor is configured to invoke different menus by invoking a first menu responsive to the actuation time having a first duration, and invoking a second menu responsive to the actuation time having a second duration.

22. The mobile device of claim 20 wherein the menu selection input control comprises one of a joystick control and an options control.
